(19) United States
(12) Patent Application Publication
(10) Pub. No.: US 2008/0181728 A1
(43) Pub. Date: Jul. 31, 2008

(54) Pipe bursting and replacement apparatus and method

(76) Inventors: Steven W. Wentworth, Brookfield, WI (US); Robert F. Crane, Oconomowoc, WI (US)

Correspondence Address: Philip G. Meyers;Philip G. Meyers Law Office, 1009 Long Prairie Road, Suite 302, Flower Mound, TX, 75022, US

(21) Appl. No.: 12/005,031

(22) Filed: Dec. 21, 2007

Related U.S. Application Data
(63) Continuation of application No. 10/837,098, filed on Apr. 30, 2004, now abandoned.
(60) Provisional application No. 60/467,829, filed on May 2, 2003.

(51) Int. Cl. F16L 55/18

(52) U.S. Cl. 405/184.3

(57) ABSTRACT

A pipe bursting and pulling apparatus for use in replacing horizontal underground pipes including a cylindrical body with a tapered forward section including means for attaching one of a cable, rod, rope or chain, the cylindrical body including an annular inner wall defining a longitudinally extending, rearwardly opening recess, a shaft passing through the recess, a plurality of gripping jaws, at least one of the jaws including a pipe gripping tooth extending radially outward relative to a longitudinal axis of the shaft, a tapered expander connected to the shaft and configured to fit between the jaws, the expander forcing the jaws outward to clamp a replacement pipe inserted into the cylindrical body between the jaws and the inner wall when pulled by the shaft, a stop, the stop limiting the forward travel of the expander and preventing outward radial travel of the jaws after the tooth has been engaged in the wall of the replacement pipe whereby the tooth penetrates to a depth of no more than 35% of the thickness of the wall of the replacement pipe.

This application is a continuation of U.S. patent application Ser. No. 10/837,098, filed Apr. 30, 2004, pending which claims priority of U.S. Provisional Patent Application Ser. No. 60/467,829, filed May 2, 2003.

### TECHNICAL FIELD

The invention relates to replacing horizontal underground pipes and in particular to an improved apparatus and method for simultaneously bursting and expanding an existing pipe while simultaneously pulling a replacement pipe through the bore with a unitary tool.

### BACKGROUND OF THE INVENTION

Existing techniques for replacing existing underground horizontal pipe include a method in which a bursting or slitting tool is pulled through the pipe with a cable, rope, chain or similar pulling means. As the tool is pulled through the pipe, it bursts and expands the bore, readying the bore for a replacement pipe. In one variation, the replacement pipe is pulled through the bore in a separate operation using a pulling apparatus connected to the end of the replacement pipe. In another variation the pulling apparatus and replacement pipe are towed behind the bursting apparatus so that the existing pipe is burst and expanded and the replacement pipe is installed in a single pass. In many applications, the replacement pipe is formed from a plastic material such as PVC or HDPE. As is well known, such plastic materials are subject to deformation under load to a greater extent than metals such as steel.

Systems used in the above described process typically include an expander cone pulled ahead of a separate pipe puller. The expander cone and the pipe puller comprise two separate components that are each loaded with separate forces during the pipe replacement operations. The longitudinal forces or loads produced during pipe replacement using such separate components may be divided and designated as either bursting work, defined as the load to crack the pipe and expand the ground, or pipe friction. Pipe friction is generated when the ground collapses back onto the pipe and adheres to its surface, not unlike clay sticking to a shovel. Normally the bursting load is a significantly larger load than a load resulting from pipe friction.

The preferred attachment used in pipe puller for pulling HDPE pipe behind a static burst head is of the type known as an expanding taper puller. This system is preferred over other methods because it is easy to install, more or less foolproof and relatively easy to remove from the pipe. To install such a puller, the puller stem is rotated until a male cone is loose from a mating conical bore, located within expanding jaws. The jaws are now in a state of diametrical contraction, and will slip into the plastic pipe. After the jaws are inserted into the pipe, the stem is rotated until the male cone pulls into the mating form of the jaws and pushes the jaws out into the wall of the pipe. Sharp protrusions machined into the profile of the jaw will grip the inside diameter of the pipe. See, for example, Brewis et al. U.S. Pat. No. 5,671,953, Sep. 30, 1997.

A drawback of existing tapered puller systems is that the load applied by the pulling process typically draws the cone even deeper into the jaws, forcing the jaws deeper into the pliable wall of the plastic pipe. More grip force is produced as the pulling resistance is increased.

Ideally, a pipe puller design would allow the pipe to stay engaged to the puller jaws even when the tensile load of the pipe is exceeded at which point the pipe will stretch, finally failing and breaking. However, conventional pullers are designed such that the load applied to the forward surface of the pipe puller is passed through the stem to the jaws during the pulling process. If the stem load exceeds the maximum tensile strength of the plastic pipe, the jaws will cause the pliable pipe to extrude and thin out. This extrusion and thinning process can result in the pipe failing before the loading on the pipe exceeds the maximum tensile strength of the pipe.

Thus, expanding taper pullers have not been successfully used in systems and applications where the force of the bursting operation is transferred to the pipe gripping jaws. Consequently, other fastening systems have been utilized. In one such system, a concentric flange is fused to the leading end of the pipe. A large bolt then secures the flanged end of the pipe to the rear of the burst head or mole. While this system apparently works, it has the disadvantage of requiring the operator to have fusing equipment on site during attachment of the pipe to the head. The fusing process is time consuming, includes the potential of a bad fuse joint, and requires expensive equipment.

Thus, there exists a need for a tapered cone type pipe pulling system that can be used in a combined unitary static pipe bursting and pulling tool. Other designs have used the travel stop flange on the cone, however these designs have been intended for a very wide range of pipe walls. The replacement pipe used for static pull pipe bursts is nearly always SDR 17 or SDR 21. These SDR values represent pipes with two very similar wall choices. When used with a pipe of known wall, the design shown here having a predetermined jaw expansion will be capable of bearing both the bursting load and pipe friction load without extruding or overstressing the pipe.

### SUMMARY OF THE INVENTION

The invention provides a unitary pipe bursting and pulling tool including a tapered cone pipe puller that limits the magnitude of the load applied to toothed pipe gripping jaws irrespective of the total load placed on the tool. A tapered cone pipe pulling system of the invention limits the axial displacement of the cone to allow the jaws a limited amount of radial displacement. Thus, a replacement pipe may be clamped onto the tool with the deformation of the pipe due to the clamping being limited such that the tensile strength of the pipe is not compromised. In one embodiment, the axial displacement of the cone is limited so that teeth of the pipe gripping jaws penetrate the wall of the replacement pipe to a depth of no more than about 35%, preferably from between 5% and 30%, of the thickness of the replacement pipe wall.

A pulling apparatus for use in replacing horizontal underground pipes according to one aspect of the invention includes a pipe bursting head having a central lengthwise hole therethrough and a pipe griping mechanism disposed behind the hole. The pipe gripping mechanism includes a plurality of gripping jaws, at least one of the jaws having a pipe gripping tooth extending radially outwardly, and a tapered expander configured to fit between the jaws such that the expander can move forwardly to force the jaws outwardly to engage a replacement pipe. Suitable means are provided for pulling the expander forward relative to the griping jaws in order to pull the pipe bursting head forward. Preferably, a stop mechanism is provided to limit forward travel of the expander and prevent outward radial travel of the jaws after the tooth has been engaged in the wall of the replacement pipe.

The invention further provides a method for replacement of a pipeline. An elongated pulling device such as a cable is threaded through an existing pipeline, and the pulling device is connected to a pipe bursting and replacement device of the invention. A replacement pipe is connected to the pipe bursting and replacement device by inserting the replacement pipe over the gripping jaws and then pulling the expander forward so that the tooth engages an inner wall of the replacement pipe. The bursting device and replacement pipe are then pulled through the pipeline using the pulling device, whereby the bursting head bursts the existing pipeline and simultaneously pulls the replacement pipeline behind it. The step of engaging the replacement pipe with the tooth (or teeth) may occur during the initial part of the pipe bursting run as the device is positioned at the entry side of the existing pipeline. The pipe pulling machine is positioned at the exit side, such as in a manhole or receiving pit. Unlike in a typical pipe pulling run, the bursting head has a greater diameter than existing pipeline and/or is provided with a blade or other projections for bursting the existing pipeline. These and other aspects of the invention are more fully discussed in the detailed description that follows.

### BRIEF DESCRIPTION OF THE DRAWINGS

FIG. 1 is a perspective view of a tapered burster and pipe pulling apparatus according to the invention;

FIG. 2 is a partial exploded view of the apparatus of FIG. 1;

FIG. 3 is top view of the pipe pulling apparatus of FIG. 1;

FIG. 4 is a cross-sectional view of the pipe expanding and pulling apparatus of FIG. 3, taken along line 4-4;

FIG. 5 is top perspective view of a pipe expander/slitter incorporating a pipe pulling apparatus according to the invention;

FIG. 6 is a first cross-sectional view of the pipe slitter of FIG. 5, taken along line 6-6;

FIG. 7 is a second cross-sectional view of the pipe slitter of FIG. 5, taken along line 7-7;

FIG. 8 is a cross-sectional view of a unitary pipe bursting and pulling apparatus wherein the expander cone and jaws are configured and applied to a replacement pipe in accordance with the invention; and

FIG. 9 is a cross-sectional view of a pipe bursting and pulling apparatus wherein the jaws have deformed the replacement pipe there by weakening the pipe.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and are not to delimit the scope of the invention. References to “tapered” or “conical” shapes or surfaces shall be understood to include not only those exact shapes but also similar shapes approximating those shapes. References to “bursting” will be understood to include both shattering of a frangible pipe and slitting of a ductile pipe, the method of the invention being useful for both of these purposes.

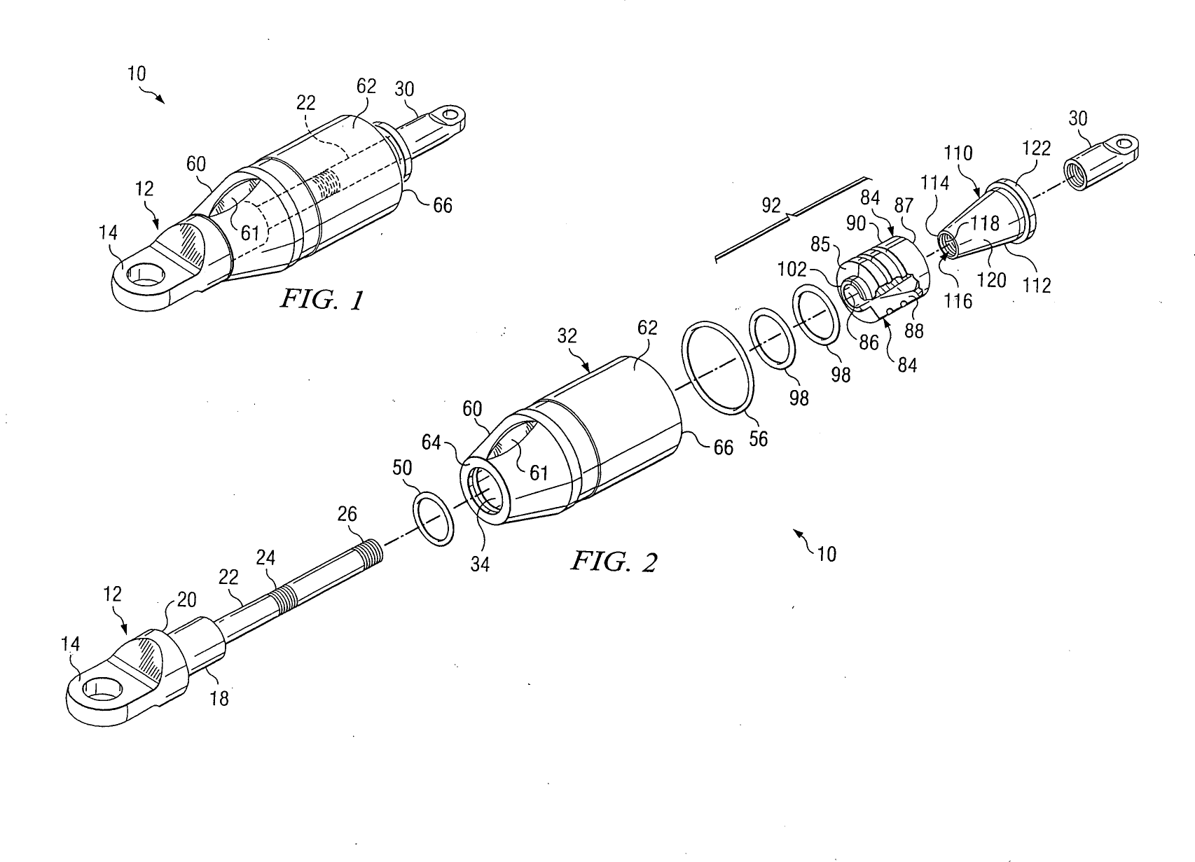

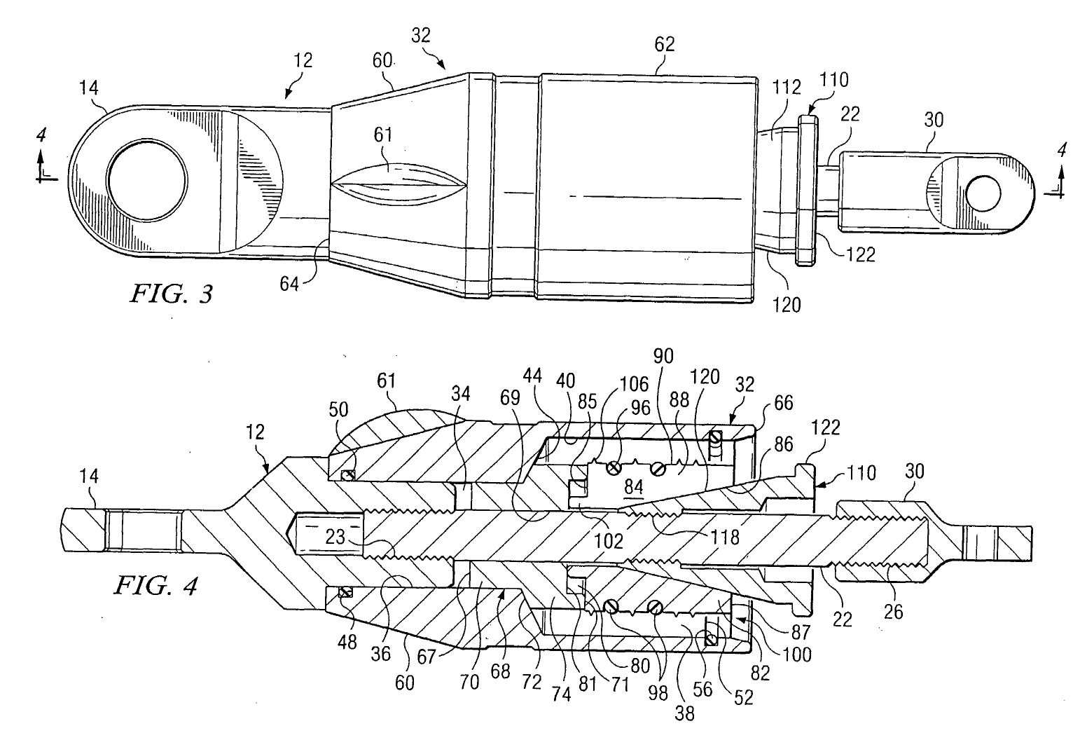

Referring now to FIGS. 1 through 4, in a first embodiment, a unitary pipe bursting and pulling apparatus 10 according to the invention is designed to be pulled though a horizontal under ground pipe, bursting and/or expanding the pipe while simultaneously pulling a replacement pipe into the bore. Any conventional pipe pulling machine may be used for this purpose, but a cyclic pipe puller that uses a cable is preferred, such as the PB30 available from Earth Tool Company LLC, described in commonly-assigned copending U.S. Ser. No. 10/352,267, filed Jan. 27, 2003, the contents of which are incorporated by reference herein, or the pullers described in part in Carter et al. U.S. Pat. No. 6,305,880, issued Oct. 23, 2001. Apparatus 10 includes a nose 12 with an eyelet 14 for connecting the apparatus to a cable, rope, chain or rod string for pulling the apparatus through a bore. A cylindrical extension 18 extending rearwardly from end wall 20 of nose 12 includes a rearwardly opening threaded hole 23 for receiving a central stem or shaft 22.

Eyelet 14 is adapted for connecting apparatus 10 to a cable, rope, string of rods, chain or similar elongated pulling device. As best illustrated in FIGS. 2 and 4, axially extending center shaft 22 is engaged in hole 23 and includes a center threaded section 24 and threaded end portion 26 adapted to receive an end eyelet 30. End eyelet 30 is designed to receive a rope or cable that is attached to the trailing end of a replacement pipe section (not shown) pulled behind apparatus 10 to aid in pulling the section through a bore during the pipe replacement operation.

A hollow, generally cylindrical body 32 comprising the bursting head positioned over extension 18 and shaft 22 includes a small diameter forwardly opening annular recess 34, with a first inner wall 36 and a large diameter rearwardly opening annular recess 38 defining a second inner wall 40. A tapered inner wall 44 extends between first and second inner walls 36, 40. Inner wall 36 includes a groove 48 for receiving an O-ring 50 to prevent debris from entering between nose 12 and cylindrical body 32. Inner wall 40 similarly includes a groove 52 for receiving O-ring 56 to seal between inner wall 40 and a pipe (not shown) inserted therein. As illustrated, cylindrical body 32 also includes a conical exterior wall 60 that is rearwardly inclined from the foremost end 64 of the body to a cylindrical outer wall 62 that extends to the rearmost end 66 of body 32. A bursting ridge or blade 61 configured to create a localized intense pressure against the inside diameter of a pipe to be burst, extends along tapered wall 60 between foremost end 64 of body 32 and cylindrical outer wall 62.

As best illustrated in FIG. 4, a sleeve 68 includes a front end wall 67, a rear end wall 71 and central axial opening 69 sized to fit over shaft 22 inside body 32. Sleeve 68 includes a small diameter forward section 70, a tapered shoulder 72 configured to abut tapered inner wall 44 and a large diameter rear section 74 with a counterbored recess 80 including an interior end wall 81 formed in rear wall 71 of sleeve 68. In one embodiment, sleeve 68 is press fitted into body 32 with forward section 70 fitting into annular recess 34 and large diameter rear section positioned in annular recess 38 of body 32.

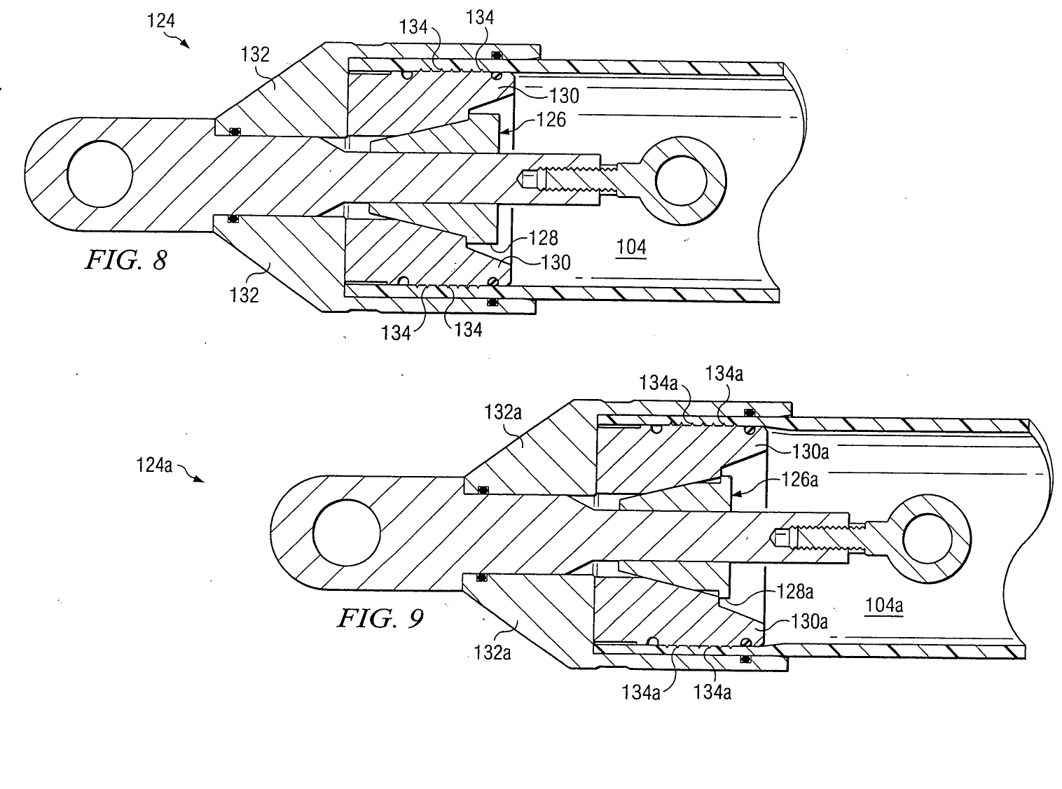

A plurality of semi-cylindrical jaws 84 each having a front wall 85, an arcuate inner wall 86, radially extending side walls 88, an arcuate outer wall 90, and a tapered end section 82 are arranged in a cylindrical pattern around shaft 22, forming a cylindrical jaw assembly 92 that extends rearward from sleeve 68. As illustrated, jaw assembly 92 comprises three jaws 84, each of which extends approximately 120° circumferentially around shaft 22. Although as illustrated, three jaws 84 are utilized, jaw assembly 92 may comprise a greater or lesser number of jaws depending upon the specific design and application. Each of jaws 84 includes a plurality of grooves 96 for receiving elastomeric O-rings 98 which hold jaws 84 together around shaft 22. Jaw assembly 92 and inner wall 40 define an rearwardly opening annular pipe receiving aperture 100, into which the foremost end of a pipe 104 (FIG. 8) may be inserted.

Each of jaws 84 also includes a forwardly extending flange 102 configured to fit into counterbored recess 80 and a plurality of serrations 106 formed across arcuate outer wall 90. As shown in FIG. 4, arcuate inner walls 86 of jaws 84 are tapered radially outward in a rearward direction to receive a conical expander 110 having a tapered body 112 with a foremost end 114 inserted between jaws 84 and shaft 22. Expander 110 includes a central opening 116 with a threaded inner wall 118 adapted to be threadedly engaged with center threaded section 24 of center shaft 22, a tapered outer wall 120 and travel stop flange 122. As expander 110 is advanced by threading the expander onto threaded portion 24 of shaft 22, expander 110 forces jaws 84 radially outward from shaft 22. In order to allow for outward movement of jaws 84 counterbored recessed 80 is sized such that flanges 102 may move radially outward a limited distance from shaft 22 within the recess.

To install apparatus 10 on the end of a replacement pipe, the end of the pipe 104 (FIG. 8) is inserted into annular aperture 100 between jaws 84 and inner wall 40. While body 32 is restrained, eyelet 14 is pulled forward, causing conical expander 110 to engage and push jaws 84 radially outward so that serrations 106 engage and dig into the interior diameter of pipe 104. Eyelet 14 is then rotated, causing conical expander 110 to be drawn forward on threaded center section 24 of shaft 22, clamping pipe 104 between jaws 84 and inner wall 40. Eyelet 14 is rotated until stop flange 122 is abutted against rear walls 87 of jaws 84 and front walls 85 of jaws 84 are pushed against rear wall 71 of sleeve 68. At this point, conical expander 110 can not be advanced any further forward on shaft 22, and jaws 84 have consequently been extended radially outward from shaft 22 to the maximum extent possible. A towing cable, rope or chain is attached to eyelet 14 and apparatus 10 is ready to be inserted into an existing pipe to be replaced.

In accordance with the invention, jaws 84 are sized such that when jaw assembly 92 has been expanded to the maximum extent possible, pipe 104 is clamped between jaws 84 and inner wall 40 with serrations 106 engaged in the inside diameter of a replacement pipe 104. (FIG. 8) Although pipe 104 is securely clamped, deformation of the pipe is non-existent or limited to a small, predetermined amount corresponding to the maximum radial extension of jaws 84 permitted by stop flange 122. Preferably, stop flange 122 is configured to limit radial extension of jaws 84 so that penetration of serrations 106 into the wall of replacement pipe 104 is limited to between 5% and 30% of the thickness of the pipe wall. Since jaws 84 have not significantly deformed pipe 104, the tensile strength of the pipe has not been compromised, and the pipe is much less likely to break as it is pulled behind apparatus 10. As one skilled in the art will understand, the dimensions of the jaws 84 and tubular wall 40 are selected to match the diameter and thickness of the replacement pipe. Tubular wall 40 is preferred to provide a more secure connection with the replacement pipe, but could be omitted. In such a case, the apparatus would rely entirely on the jaws to hold the replacement pipe.

In order to fully appreciate this advantage, FIG. 8 illustrates a unitary pipe bursting and pulling apparatus 124 according to the invention with a plastic replacement pipe 104 clamped in the apparatus. As illustrated, expander 126 is positioned such that stop flange 128 is abutted against jaws 130 which in turn are abutted against expander body 132 such that jaws 130 have reached maximum limit of radial extension permitted by stop flange 128. In this position, the gripping teeth or serrations 134 of jaws 130 are engaged in the inside diameter of pipe 104, however, jaws 130 have not dug into or deformed the pliable plastic pipe 104. Thus, tensile strength of pipe 104 has not been significantly impacted by the clamping action of jaws 130 and the pipe should be capable of being loaded to its maximum tensile strength without failing.

FIG. 9 illustrates a hypothetical bursting and pulling apparatus 124a that does not include the features of the invention. In the apparatus illustrated in FIG. 9, the jaws 84a, expander 126a and stop flange 128a are not configured to stop the radial extension of jaws 84a before pipe 104 is deformed. As illustrated, expander 126a has been advanced and jaws 130 expanded outward to the point that the jaws 130a have compressed and deformed pipe 104a, causing the wall of the pipe to become thinner and thus reducing the tensile strength of the pipe. Consequently, when pipe 104a is pulled behind apparatus 124a in a bore, the pipe is more likely to fail prior as the load on the pipe is increased.

In order to fully appreciate the difference between apparatus 124 and 124a, it must be understood that when a plastic pipe, for example a pipe formed from PVC or HDPE, is pulled through a bore, the longitudinal force on the pipe due to friction between the pipe and the bore is large, placing significant longitudinal tensile stress on the pipe. As the tensile stress increases, the wall of the pipe tends to elongate, becoming thinner as the pipe is stretched. If the pipe wall is compressed to the point of deformation between gripping jaws and the inner wall of a puller as illustrated in FIG. 9, the pipe is weakened at that location, and the probability of a failure is greater than if the pipe were not compressed. In contrast, pipe 104 clamped in apparatus 124, while securely clamped in the apparatus is not deformed, and consequently is much less likely to fail.

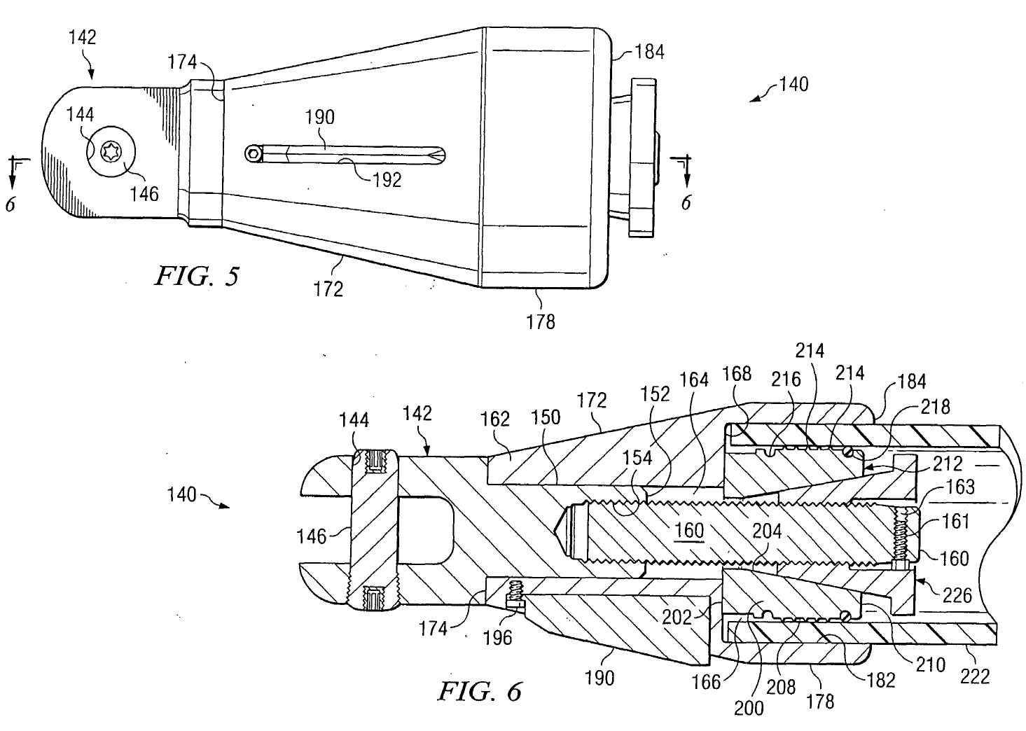

Turning now to FIGS. 5-7, in an alternate embodiment, a pipe slitter and pulling apparatus 140 according to the invention comprises a yoke 142 with an aperture 144 and pin 146 adapted to connect slitter 140 to a flexible pulling means such as a rope, cable or chain. Yoke 140 includes a stem or shaft like extension 150 having a rear most end 152 with a threaded opening 154 extending axially into end 152. A threaded center shaft 160, engaged in opening 154 extends rearward from yoke 142. As illustrated, center shaft 160 passes through a slitter body 162 that includes a first annular opening 164 within a first inner wall 180 sized to fit over extension 150. A second, larger diameter annular opening 166 defined by a second inner wall 182 extends rearwardly from first opening 164 with a intermediate wall 168 between first and second openings 164, 166. A conical outer wall 172 extends from the front most end 174 of body 162 to a cylindrical outer wall 178 that extends between conical wall outer wall 172 and the rearmost end 184 of the body.

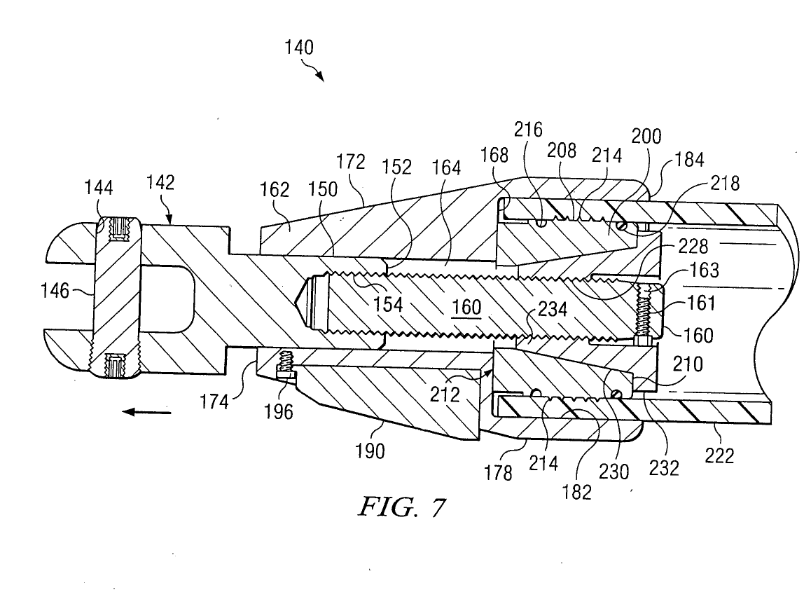

As illustrated, a slitter blade 190 is mounted in a longitudinally extending slot 192 in slitter body 162. Slitter blade 190 is configured and adapted to slit existing pipe in horizontal bore as slitting tool 140 is pulled through the bore with a winch or similar pulling device. As best illustrated in FIGS. 6 and 7, slitter blade 190 is secured in slot 192 with a set screw or bolt 196. Alternatively, slitter blade 190 may be welded in place.

A plurality of semi-cylindrical jaws 200, each having a front wall 202, a tapered arcuate inner wall 204, radially extending side walls, similar to side walls 88 of jaws 84 of FIG. 4, an arcuate outer wall 208, and a rear end wall 210 are positioned around the circumference of center shaft 160, forming a cylindrical jaw assembly 212. Jaw assembly 212 comprises three jaws 200, arranged in the same fashion as jaws 84 of FIGS. 2 and 4 each of which extends approximately 120° circumferentially around center shaft. Each of jaws 200 includes a plurality of grooves 216 for receiving O-rings 218 that hold jaws 200 in position around center shaft 160. Each of jaws 200 also includes a plurality of teeth or serrations 214 extending across the circumference of outer wall 208 of the jaw. As illustrated, jaw assembly 212 and second inner wall 182 form an annular pipe receiving aperture 220 for receiving a pipe 222.

Referring to FIG. 6, a conical expander 226 is illustrated in a first position wherein the expander is threaded onto center shaft 160 and received between tapered inner walls 204 of jaws 200 and center shaft 160. Expander 226 includes a threaded annular hole 228, and an outer wall 230 that is tapered from a stop flange 232 to the narrow forward most end 234 of the expander. As illustrated in FIG. 6, apparatus 140 is configured with expander 226 in a loosened position such that the end of pipe 222 can be fitted into annular receiving aperture 220. To prevent expander 226 from being rotated off of center shaft 160 when the expander is loosened, a retainer pin 161 is treaded into a retainer hole 163 formed at the rear end of shaft 160.

After pipe 222 is positioned as illustrated in FIG. 6, yoke 142 is pulled in a forward direction, illustrated by the arrow, while slitter body 162 is restrained, causing expander 226 to bear against jaw assembly 212 and force jaws 200 radially outward so that serrations 214 engage the inner diameter of pipe 222. Center shaft 160 is then rotated by turning yoke 142, drawing expander 222 forward on the shaft. As expander 226 is drawn forward, the expander forces jaws 200 radially outward causing serrations 214 to penetrate the inside wall of pipe 222. Center shaft 162 is rotated in this manner until expander 226 and jaws 220 are moved into the position illustrated in FIG. 7 wherein stop flange 232 has been drawn up against rear end walls 210 of jaws 200 and the front walls 202 of jaws 200 are abutting intermediate wall 168. In this position, pipe 222 is firmly clamped between jaw assembly 212 and inner wall 182 with serrations 214 engaged in the inner wall of the pipe. When expander 226 has been drawn forward to the position illustrated in FIG. 7, the expander cannot be moved further forward; consequently, jaws 200 are at the outer limit of possible radial travel. In a preferred embodiment, when jaws 200 are at the outer limit of possible radial travel, serrations 214 have penetrated to a depth of between 5% and 30% of the thickness of the wall of pipe 222. Thus, although firmly clamped in this position, the wall of pipe 222 is not compressed to the extent that the wall deforms because the outward movement of jaw assembly 212 has been limited by stop flange 232 of expander 226.

In operation, pipe slitter and pulling apparatus 140 is pulled through an existing under ground pipe with a cable, chain or rope secured to yoke 142. As apparatus 140 moves through the pipe, slitter blade 190 cuts or scores the pipe which is expanded by conical outer wall 172 of slitter body 162. Simultaneous, apparatus 140 is pulling a replacement pipe 222 through the expanded bore. The friction between replacement pipe 222 and the bore results in a significant tensile loading on the pipe which tends to elongate the pipe, causing the wall of the pipe to stretch and become thinner. This effect is particularly significant at the end of pipe 222 where the pipe is clamped to apparatus 140 as described above. Thus, by insuring pipe 222 is not deformed at the clamped location, apparatus 140 can utilize the available tensile strength of the undeformed pipe without increasing the probability of breaking the pipe.

While this invention has been described with reference to illustrative embodiments, this description is not intended to be construed in a limiting sense. The apparatus could, for example, omit the central shaft and instead use a portion of the cable or other pulling device extended through the central hole in the bursting head and secured in any suitable manner, such as by a knot, upset or stop, or by securing the cable with self-actuating cable gripping collets. Although a conically tapered bursting head is preferred, a stepped head could also be used. Various other modifications and combinations of the illustrative embodiments, as well as other embodiments of the invention, will be apparent to persons skilled in the art upon reference to the description. It is, therefore, intended that the appended claims encompass any such modifications or embodiments.

1. A pipe bursting and replacement apparatus for use in replacing horizontal underground pipes comprising:
a pipe bursting head having a central lengthwise hole therethrough;
a pipe gripping mechanism disposed behind the hole, including a plurality of gripping jaws, at least one of the jaws having a pipe gripping tooth extending radially outwardly, and a tapered expander configured to fit between the jaws such that the expander can move forwardly to force the jaws outwardly to engage a replacement pipe;
means for pulling the expander forward relative to the jaws in order to pull the pipe bursting head forward; and
a stop limiting forward travel of the expander and preventing outward radial travel of the jaws after the tooth has been engaged in the wall of the replacement pipe.

2. The apparatus of claim 1, wherein the stop causes the tooth to penetrate to a depth of no more than 35% of the thickness of the wall of the replacement pipe.

3. The apparatus of claim 1, wherein the pipe bursting head comprises a generally conical, forwardly tapering body.

4. The apparatus of claim 1, wherein the pipe bursting head has a pipe bursting projection on its frontwardly facing outer surface.

5. The apparatus of claim 4, wherein the pipe bursting projection comprises a blade.

6. A pipe bursting and replacement apparatus for use in replacing horizontal underground pipes comprising:
a cylindrical body with a tapered forward section including means for attaching one of a cable, rod, rope or chain;
the cylindrical body further comprising an annular inner wall defining a longitudinally extending, rearwardly opening recess;
a shaft passing through the recess;
a plurality of gripping jaws, at least one of the jaws comprising a pipe gripping tooth extending radially outward relative to a longitudinal axis of the shaft;
a tapered expander connected to the shaft and configured to fit between the jaws, the expander forcing the jaws outward to clamp a replacement pipe inserted into the cylindrical body between the jaws and the inner wall when pulled by the shaft;
a stop, the stop limiting the forward travel of the expander and preventing outward radial travel of the jaws after the tooth has been engaged in the wall of the replacement pipe; and
wherein the tooth penetrates to a depth of no more than 35% of the thickness of the wall of the replacement pipe.

7. A method for replacement of a pipeline, comprising:
threading an elongated pulling device through an existing pipeline;
connecting the pulling device to a pipe bursting and replacement device, which device includes a pipe bursting head having a central lengthwise hole therethrough, a replacement pipe gripping mechanism disposed behind the hole, including a plurality of gripping jaws, at least one of the jaws having a pipe gripping tooth extending radially outwardly, and a tapered expander configured to fit between the jaws, such that the expander can move forwardly to force the jaws outwardly to engage a replacement pipe, and further includes means for connecting the elongated pulling device to pull the expander forward relative to the gripping jaws in order to pull the pipe bursting head forward;
connecting a replacement pipe to the pipe bursting and replacement device by inserting the replacement pipe over the gripping jaws and then pulling the expander forward so that the tooth engages an inner wall of the replacement pipe; and
pulling the bursting head and replacement pipe through the existing pipeline using the pulling device, whereby the bursting head bursts the existing pipeline and simultaneously pulls the replacement pipeline behind it.

8. The method of claim 7, wherein the pipe bursting and replacement device further includes a shaft extending through the hole in the bursting head, the shaft having an eyelet at a front end portion thereof, and having a threaded rear portion on which the expander is mounted, and the step of connecting the pulling device to a pipe bursting and replacement device further comprises securing an end portion of the pulling device to the eyelet.

9. The method of claim 7, wherein the pulling device is a cable, and the pulling step is executed is a series of cyclic pulling strokes by a cable pulling machine positioned at one end of the existing pipeline.

10. The method of claim 8, wherein the pulling device is a cable, and the pulling step is executed is a series of cyclic pulling strokes by a cable pulling machine positioned at one end of the existing pipeline.

11. The method of claim 7, wherein the bursting head has an external blade thereon that ruptures the existing pipeline during the step of pulling the bursting head and replacement pipe through the existing pipeline.

12. The method of claim 7, wherein the connecting means comprises an eyelet.

13. The method of claim 7, wherein the connecting means comprises a yoke.

14. A pipe bursting and replacement apparatus for use in replacing horizontal underground pipes, comprising:
a pipe bursting head comprising a forwardly tapering body having a central lengthwise hole therethrough, and having a pipe bursting projection on its frontwardly facing outer surface;
a shaft extending through the hole in the bursting head having a protruding front end portion configured for connection to an elongated pulling device;
a pipe gripping mechanism disposed behind the hole through the head, including a plurality of gripping jaws and a tapered expander mounted on the shaft and configured to fit between the jaws such that the expander can move forwardly in response to pulling on the shaft to force the jaws outwardly to engage a replacement pipe.

15. The apparatus of claim 14, wherein the pipe bursting projection comprises a blade configured to create a localized intense pressure against the inside diameter of a pipe to be burst.

16. The apparatus of claim 14, wherein the frontwardly facing outer surface of the bursting head is conical in a frontwardly tapering direction, and the pipe bursting projection comprises a blade configured to create a localized intense pressure against the inside diameter of a pipe to be burst, wherein the blade extends in a lengthwise direction of the bursting head along the frontwardly facing, conical outer surface.

17. The method of claim 14, wherein the protruding front end portion comprises an eyelet.

18. The method of claim 14, wherein the protruding front end portion comprises a yoke.

19. The method of claim 14, wherein the pipe gripping mechanism further comprises one or more radial pipe gripping teeth which engage the pipe as the jaws are forced outwardly to engage a replacement pipe.

20. The method of claim 19, wherein the pipe gripping teeth are disposed on the gripping jaws and extend outwardly for engaging an inner surface of the replacement pipe.
